(19) United States
(12) Patent Application Publication
(10) Pub. No.: US 2003/0095101 A1
(43) Pub. Date: May 22, 2003

(54) Computer peripherial pointing device with power generating means

(76) Inventor: Chewnpu Jou, Hsinchu Hsien (TW)

Correspondence Address: J.C. Patents, Inc., 4 Venture, Suite 250, Irvine, CA, 92618, US

(21) Appl. No.: 09/990,975

(22) Filed: Nov. 21, 2001

(51) Int. Cl. G09G 5/08

(52) U.S. Cl. 345/163

(57) ABSTRACT

A computer peripheral point device with a power generating means that allows for extended lifetime of a devices batteries. The present invention discloses an apparatus wherein a generator is driven by the rotation of a mouse ball through an adjacent roller. In another embodiment the downward force of “clicking” the mouse is converted into electrical energy through a piezoelectric generator. In another embodiment of the invention an eccentric mass generator converts the kinetic energy from the movement of the mouse into electrical energy. In yet another embodiment a plurality of solar cells are placed on the external surface of a point device converting available light into electrical energy.

### FIELD OF THE INVENTION

The present invention relates to a computer peripheral device such as a mouse that includes a means for generating power utilized by the device.

### BACKGROUND OF INVENTION

Computer mouses are common peripheral devices found with most personal computers. The most common type of mouse are mechanical mouses that include longitudinal (X) direction sensors and lateral (Y) direction sensors responsive to the revolution of a sensing ball adapted to roll on a subjacent surface. As shown in a bottom view of a mouse in FIG. 1, a mouse 10 includes a ball 11. Adjacent to the ball 11 are rollers 12 and 13 that are in contact with the ball and rotate depending on the X or Y rotation of the ball 11. Rollers 12 and 13 are connected to optical encoders 14. The optical encoders 14 consist of a circular plate 15 attached at the center of the roller shaft having a plurality of holes around its periphery, so that the rotation of the roller (12 and 13) forces the circular plates 15 to be rotated. The optical encoder 14 includes paired photo-couplers mounted on both side surfaces adjacent to the holes perforated around its periphery. For example, a light emitting diode 16 of the photo-coupler is positioned on the front surface of the circular plate and the photo-transistor 17 on the rear surface. Therefore the circular plates 15 are rotated as the rollers (12 and 13) are rotated in contact with the ball 11. The photo-couplers 14 are operated such that the photo-transistors 17 receive the light from the light emitting diode 16 facing thereto as a hole appears in the circular plate 15 between them. Likewise the phototransistor is turned off when a hole is not present. Thus the position displacements of the ball 11 are determined in the X and Y axis by the phase differences occurred as to whether the photo-transistors 17 receive the light, or not during the lighting of the light emitting diodes 16.

To receive the position signals the most common approach is to attach the mouse to a computer using a cable through either an industry standard serial (RS-232) or parallel port. The cable however restricts the movement of the mouse, which many users find very frustrating. This has led to the use of wireless mouses or in other words mouses that communicate by means other than wires typically using infrared or RF signals. Mori in U.S. Pat. No. 4,745,268 teaches the operation of a wireless mouse. As the mouse is portable and must transmit as well as receive signals a power source is needed. Usually a rechargeable battery is used to supply D.C. power to the circuitry. However over time the level of energy contained in the batteries will diminish forcing the user to replace the battery. This maintenance of batteries in the wireless mouse can be very annoying, especially if the mouse fails to operate during operation. Therefore a need exists for a wireless mouse that can generate power to extend the life of is batteries or even to prevent the need for replacement.

Piezoelectric materials have long been used to convert electrical energy into mechanical energy. Their use to convert mechanical energy into electrical energy has been generally limited to stress transducers such as strain gauges. A few patents describing uses of piezoelectric materials such as U.S. Pat. No. 3,350,853 to Schiavone which discloses the use of a piezoelectric crystal in generating electrical power; U.S. Pat. No. 1,884,547 to Bower which shows an electrical system where a piezoelectric element is subjected to torsion movement to generate an electrical power output; and U.S. Pat. No. 4,100,630 to Hendel which describes a wave powered electric generator using piezoelectric elements.

Eccentric mass generators are a type of AC generator that utilize movements of the generator to turn an eccentric mass. The kinetic energy of the eccentric mass when oscillating drives a rotor wheel, which together with a stator creates AC power. Applications of an eccentric mass generators have been used in wrist watches as described in Japanese laid open patent application No. 52/68466 (1975).

Solar powered devices have long been used in consumer products such as calculators to provide a source of energy.

None of the above inventions and patents, taken either singularly or in combination, is seen to describe the instant invention as claimed.

### SUMMARY OF THE INVENTION

These and other features, which characterize the invention, are set forth in the claims annexed hereto and forming a further part hereof. However, for a better understanding of the invention, and of the advantages and objectives attained through its use, reference should be made to the drawings, and to the accompanying descriptive matter, in which there is described exemplary embodiments of the invention.

This invention relates to a computer peripheral pointing device with a power generating means. The apparatus can be applied to many human powered computer peripherals such as a wireless mouse or trackballs. As the pointing device creates its own energy this allows recharging of the devices batteries extending their useful lifetime.

In the first preferred embodiment of the invention, when a user operates a mechanical mouse a ball rotates on the underside of the mouse. Adjacent to the ball is typically two rollers that in the prior art are used for optically encoding the position of the mouse via the movement of the ball. The invention discloses an apparatus wherein a generator is driven by the rotational movement of the ball via the rollers to create electrical power to be utilized by the mouse. The electrical power is then transferred to an accompanying circuit, and then to a power storage means.

In another embodiment of the invention a piezoelectric generator is used. When a user presses down on a key or “clicks” the mouse the downward force is applied to a piezoelectric generator that creates electrical power. The electrical power is then transferred to accompanying circuit, and then to a power storage means.

In another embodiment of the invention an eccentric mass generator is placed inside the mouse. The users movement of the mouse transfers kinetic energy to the eccentric mass in the generator causing it to oscillate. The oscillation is converted into electrical energy. The electrical energy is then transferred to an accompanying circuit, and then to power storage means.

In yet another embodiment of the invention a plurality of solar cells are arranged on the exterior surface of a mouse. When the solar cells are exposed to light the resulting electrical energy is transferred to an accompanying circuit, and then to a power storage means.

### BRIEF DESCRIPTION OF DRAWINGS

FIG. 1 shows a convention mouse design

FIG. 2 shows a first preferred embodiment of the invention

FIG. 3 shows a second embodiment of the invention

FIG. 4 shows a third embodiment of the invention utilizing a piezoelectric generator

FIG. 5 shows a fourth embodiment of the invention utilizing a eccentric mass generator

FIG. 6 shows a fifth embodiment of the invention utilizing solar cells

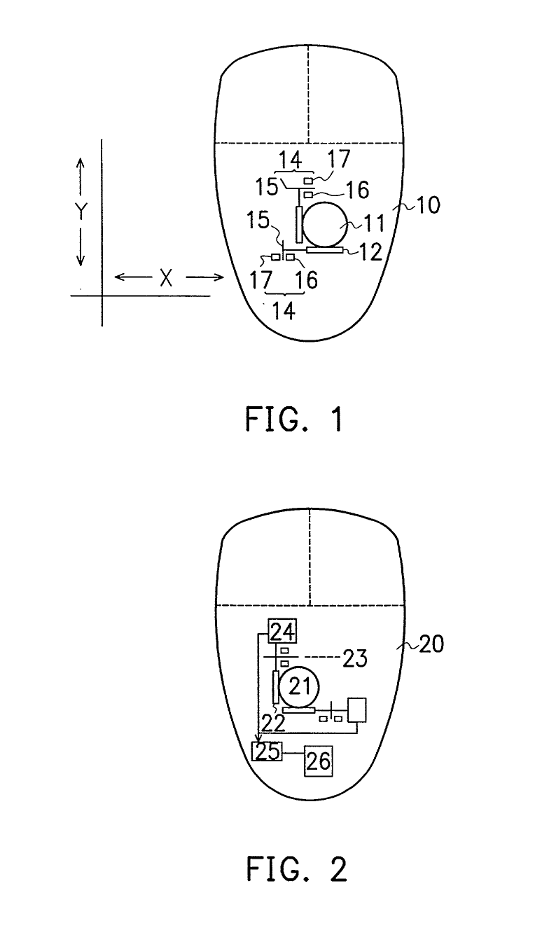

### DETAILED DESCRIPTION

In the following detailed description of the preferred embodiments, reference is made to the accompanying drawings which form a part hereof, and in which is shown by way of illustration specific preferred embodiments in which the invention may be practiced. the preferred embodiments are described in sufficient detail to enable these skilled in the art to practice the invention, and it is to be understood that other embodiments may be utilized and that logical, changes may be made without departing from the spirit and scope of the present invention. The following detailed description is, therefore, not to be taken in a limiting sense, and the scope of the present invention is defined only be the appended claims.

A bottom view of a mouse is shown in FIG. 2 exemplifying a preferred embodiment of the invention. A mouse 20 includes two rollers 22 that are mounted at an X and Y axis adjacent to a ball 21. For ease of explanation, one roller configuration will be described, as both are identical in structure. The roller 22 is in contact with a ball 21 and is rotated depending on the vertical or horizontal rotation and speed of the ball. The roller 22 has a shaft at its center, which is connected to a circular plate of an optical encoder 23, and an electrical generator 24. As the operator moves the mouse the mouse ball 21 will rotate the roller 22, which in turn rotates the wheel of the optical encoder 23 and the electrical generator 24. The electrical generator 24 will produce electricity in relation to the speed of the rotation (i.e. faster rotation, increased energy). The electrical energy produced by the generator 24 is then transferred to accompanying circuitry 25. The circuitry can include overvoltage and/or overcurrent protection, a full wave rectifier for converting the energy into direct current (D.C.), and a small capacitor for reducing the accompanying ripple. The D.C. energy can then be provided to a power storage means 26 which can include rechargeable batteries, and/or super capacitors. Often when only small amounts of energy are produced a capacitor is used to accumulate the charge, and then discharge the power when a certain threshold level has been reached. Alternatively the electricity produced by the generator 24 can pass through the accompanying circuitry 25 and then be supplied directly to the mouse circuitry. Further the invention can use a combination of any of these power usage techniques depending upon the needs of the mouse 20. Although the embodiment as shown in FIG. 2 utilizes an electrical generator on both the X and Y axis rollers, the invention can be reduced to make use of only one generator on either the X or Y axis due to the fact that in normal operation both rollers are turning the majority of the time.

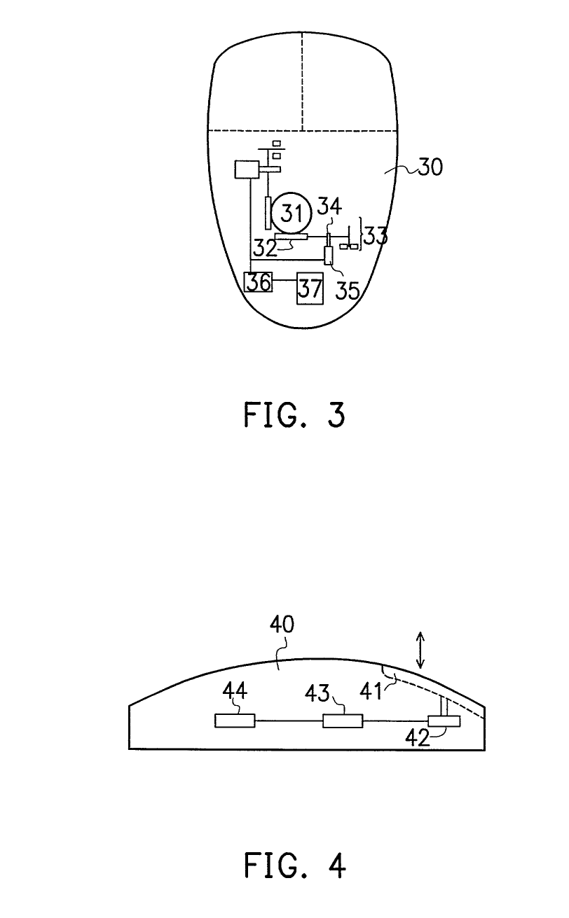

In a second embodiment of the invention as shown in FIG. 3 two rollers 32 are mounted at an X and Y axis adjacent to a ball 31. The two rollers 32 are in contact with the ball 31 and rotate depending on the vertical or horizontal rotation and speed of the ball 31. For ease of explanation, one roller configuration will be described as both are identical in structure. A roller 32 has a shaft at its center, which is connected to a circular plate of an optical encoder 33 and a gear 34. As the operator moves the mouse the mouse ball 31 will rotate the roller 32, which in turn rotates the optical encoding wheel in the optical encoder 33 and the gear 34 on the roller shaft. The gear 34 in turn transfers energy to a generator 35. This allows different gear ratios to be utilized increasing or decreasing the rotational speed of the generator 35 in relation to the rotational speed of the rollers 32. Further the use of gears allows for more design flexibility. The electrical energy produced by the generator can then be transferred to accompanying circuitry 36. The circuitry 36 can include overvoltage and/or overcurrent protection, a full wave rectifier for converting the energy into direct current (D.C.), and a small capacitor for reducing the accompanying ripple. The D.C. energy can then be provided to a power storage means 37 which can include rechargable batteries, and/or super capacitors. Often when only small amounts of energy are produced a capacitor is used to accumulate the charge, and then discharge the power when a certain threshold level has been reached. Alternatively the electrical energy produced by the generators 35 can pass through the accompanying circuitry 36 and then supplied directly to the mouse circuitry. Further the invention can use a combination of any of these power usage techniques depending upon the needs of the mouse 30. Although the embodiment as shown in FIG. 3 utilizes a gear and electrical generator on both the X and Y axis rollers, the invention can be reduced to make use of only one generator on either the X or Y axis due to the fact that in normal operation both rollers are turning the majority of the time.

Often users when operating a mouse will move the mouse until a graphical user interface (GUI) on the screen is at a desired position. The user will then cease moving the mouse and ‘click’ or depress a button on the mouse at least once. A third embodiment of the invention utilizes the mechanical energy of the depression of a key for the production of energy. One method of doing this is to utilize a piezoelectric element to generate power. As shown in FIG. 4 when a mouse key 41 is pressed it will put downward force on a piezoelectric element 42 that will result in the flow of electricity that can then be transferred to accompanying circuitry 43. The circuitry 43 can include overvoltage and/or overcurrent protection, a full wave rectifier for converting the energy into direct current (D.C.), and a small capacitor for reducing the accompanying ripple. The D.C. energy can then be provided to a power storage means 44 which can include rechargable batteries, and/or super capacitors. Often when only small amounts of energy are produced a capacitor will accumulate the charge, and then discharge the power when a certain threshold level has been reached. Alternatively the electricity produced by the generator 13 can pass through the accompanying circuitry and then supplied directly to the mouse circuitry. The embodiment as shown in FIG. 4 can be further used in conjunction with the first two embodiments of the invention allowing for more continuous charging during the mouse operation.

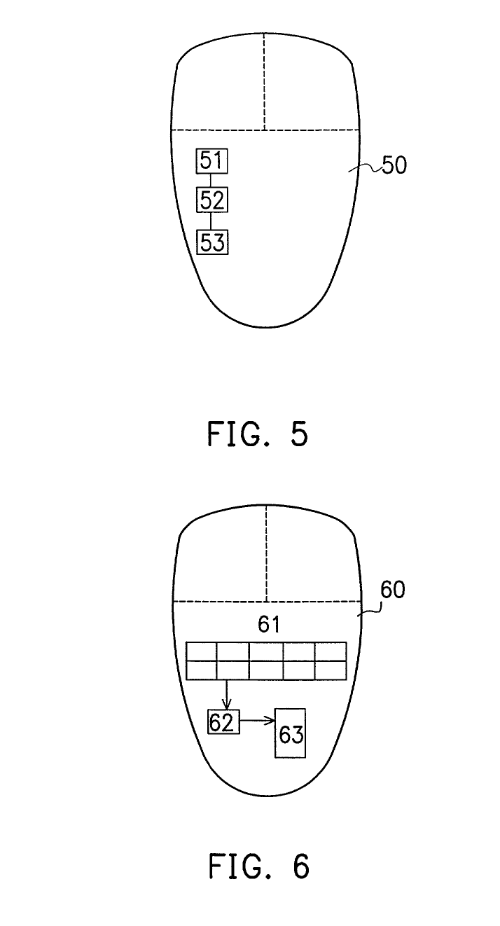

FIG. 5 shown a mouse with an eccentric mass powered generator 51. Movements of the mouse will transfer cause an eccentric mass to oscillate. Typically the eccentric mass is connected to a rotor wheel of an AC generator. The resulting electrical energy is transferred to accompanying circuitry 52. The circuitry 52 can include overvoltage and/or overcurrent protection, a full wave rectifier for converting the energy into direct current (D.C.), and a small capacitor for reducing the accompanying ripple. The D.C. energy can then be provided to a power storage means 53 that can include rechargeable batteries, and/or super capacitors. Often when only small amounts of energy are produced a capacitor is used to accumulate the charge, and then discharge the power when a certain threshold level has been reached. Alternatively the electricity produced by the generator 24 can pass through the accompanying circuitry 25 and then be supplied directly to the mouse circuitry. Further the invention can use a combination of any of these power usage techniques depending upon the needs of the mouse 50.

FIG. 6 shows a top view of a mouse 60. A plurality of solar cells 61 covers the upper external surface of the mouse casing. When the solar cells are exposed to light the cells will produce energy that will then be passed to accompanying circuitry 62. The circuitry can include overvoltage and/or overcurrent protection, a full wave rectifier for converting the energy into direct current (D.C.), and a small capacitor for reducing the accompanying ripple. The D.C. energy can then be provided to a power storage means 63 that can include rechargeable batteries, and/or super capacitors. Often when only small amounts of energy are produced a capacitor is used to accumulate the charge, and then discharge the power when a certain threshold level has been reached. Alternatively the electricity produced by the solar cells 61 can pass through the accompanying circuitry 62 and then be supplied directly to the mouse circuitry. Further the invention can use a combination of any of these power usage techniques depending upon the needs of the mouse 60. The advantages of the solar cells are that is can provide long periods of power production when the mouse is not in use.

Various additional modifications may be made to the illustrated embodiments without departing from the spirit and scope of the invention. Therefore, the invention lies in the claims hereinafter appended.

What is claimed:

1. A computer peripheral pointing device comprising:
a ball responsive to a users movements;
a plurality of rollers responsive to the movements of the ball; and
an electrical generator powered by the rotation of the rollers.

2. The computer peripheral point device of claim 1, wherein the device is a wireless mouse.

3. The computer peripheral pointing device of claim 1, further comprising a plurality of optical encoders connected to the rollers.

4. The computer peripheral pointing device of claim 1 that further includes circuitry for regulating the energy created by the generator.

5. The computer peripheral of claim 1 that further includes a power storage means

6. The power storage means of claim 5, wherein the power storage means includes rechargeable batteries.

7. The power storage means of claim 3, wherein the power storage means includes capacitors.

8. The electrical generator of claim 1, wherein the electrical generator is driven directly by the roller shaft.

9. The electrical generator of claim 1, wherein a gear on the roller shaft functions to drive the electrical generator.

10. A computer peripheral wireless mouse comprising:
A power generating means;
A power regulating circuit coupled to the power generating means;
A power storage means coupled to the power regulating circuit;

11. The wireless mouse of claim 9, wherein the power generating means includes:
a ball responsive to a users movements
a plurality of rollers responsive to the movements of the ball
an electrical generator powered by the rotation of the rollers

12. The wireless mouse of claim 11, wherein the power generating means includes an electrical generator driven by the downward motion of a mouse button.

13. The generator of claim 12, wherein the electrical generator includes a piezoelectric electrical generator.

14. The wireless mouse of claim 1, wherein the power generating means includes a plurality of solar cells arranged on the outer casing of the wireless mouse.

15. The wireless mouse of claim 1, wherein the power generating means includes an eccentric mass driven generator.
